(19) United States
(12) Patent Application Publication
(10) Pub. No.: US 2006/0136617 A1
(43) Pub. Date: Jun. 22, 2006

(54) Data transfer apparatus and data transfer method

(76) Inventor: Masashi Sasahara, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/312,770

(22) Filed: Dec. 21, 2005

(30) Foreign Application Priority Data
Dec. 22, 2004 (JP) 2004-372203

(51) Int. Cl. G06F 3/06

(52) U.S. Cl. 710/36

(57) ABSTRACT

One transfer request is selected from a plurality of transfer requests. The end time of a transfer process corresponding to an identifier attached to the selected transfer request is set. If the set end time elapses during the data transfer process based on the selected transfer request, the selected transfer request is erased.

### CROSS-REFERENCE TO RELATED APPLICATIONS

This application is based upon and claims the benefit of priority from prior Japanese Patent Application No. 2004-372203, filed Dec. 22, 2004, the entire contents of which are incorporated herein by reference.

### BACKGROUND OF THE INVENTION

1. Field of the Invention

This invention relates to a data transfer apparatus having a direct memory access device (DMA) and a data transfer method.

2. Description of the Related Art

Recently, the difference between the operation speed of a central processing unit (CPU) and that of an external bus has become larger, and the DMA process has diversified remarkably and becomes more complicated. Accordingly, a process such as a transfer process conventionally performed by the CPU tends now to be performed by DMA. Therefore, a device is provided which is configured to further reduce processing by the CPU by causing the DMA to directly receive a transfer-start event from an input/output device and perform the transfer process by using previously prepared process contents (descriptor), for example.

Further, a data transfer control device has been developed which can control a period of time from generation of a transfer request until the transfer process is actually performed or change the priority of master functions of performing the transfer processes according to the types of data items to be transferred in a data transfer process by use of the bus (for example, refer to Jpn. Pat. Appln. KOKAI Publication No. 2000-322377).

However, in the transfer process using DMA, a descriptor is previously prepared and the transfer state is managed by the DMA. Therefore, the process performed when the transfer process is interrupted for a reason on the DMA side (for example, when an error has occurred) becomes easier. However, when the DMA process becomes unnecessary due to the context of the CPU and the transfer process is interrupted, it becomes necessary to cause the CPU to perform the process of interrupting issuance of a DMA request of the channel and eliminating the descriptor from a queue of the DMA channel. Since the operation speeds of the CPU and the external bus are greatly different from each other in recent high-speed processors, the CPU must wait for a relatively long time and the performance of the process is degraded.

On the other hand, in the case of a transfer process such as a real-time input/output process for a large amount of data, for example, a high-definition video input/output process in which no interruption can be made, next data must be input/output with respect to an external device irrespective of the previous data state. Therefore, in a case where data transfer is delayed or stopped due to a jam on the internal bus of the CPU, the input/output process for subsequent data is influenced when a data transfer process which cannot be performed in time cannot be canceled. This does not cause a serious problem when the CPU finely manages the data transfer process. However, for example, the influence becomes larger in a system in which a DMA and a video input/output controller automatically start the data transfer process. That is, in a case where a long real-time transfer context configured by a plurality of descriptors is used, the performance of the system is degraded if the DMA cannot voluntarily discard the transfer process which has become invalid. Therefore, it is desired to develop a data transfer apparatus and data transfer method in which a transfer request which becomes invalid can be discarded by the DMA and the performance of the system can be prevented from being degraded.

### BRIEF SUMMARY OF THE INVENTION

According to a first aspect of the invention, there is provided a data transfer apparatus comprising a transfer processing section which transfers data in response to a transfer request; a plurality of transfer request storing sections which store a plurality of transfer requests having identifiers attached thereto; a selecting section which selects one of the plurality of transfer request storing sections, the selecting section sequentially fetching the plurality of transfer requests stored in the selected transfer request storing section and supplying the same to the transfer processing section; a first storage section which stores the identifiers and time information indicating end time of a transfer process based on the plurality of transfer requests having the identifiers attached thereto, the first storage section outputting time information based on an identifier contained in the transfer request supplied from the selecting section; and a determining section which determines processing time for the plurality of transfer requests based on time information supplied from the first storage section, the determining section generating a cancel request signal used to cancel transfer requests issued after the present transfer request and supplying the cancel request signal to the transfer request storing section when the processing time has exceeded time indicated by the time information.

According to a second aspect of the invention, there is provided a data transfer apparatus comprising a transfer processing section which transfers data in response to a transfer request; a plurality of transfer request storing sections which store a plurality of transfer requests having identifiers attached thereto; a selecting section which selects one of the plurality of transfer request storing sections, the selecting section sequentially fetching the plurality of transfer requests stored in the selected transfer request storing section and supplying the same to the transfer processing section; and a determining section which generates a cancel request signal used to cancel transfer requests issued after the present transfer request and supplying the cancel request signal to the transfer request storing section when end time of the transfer process set based on the plurality of transfer requests has exceeded present time supplied from the exterior.

According to a third aspect of the invention, there is provided a data transfer method comprising selecting one of a plurality of transfer requests; setting end time of a transfer process corresponding to an identifier attached to the selected transfer request; and erasing the selected transfer request when the set end time has elapsed during the data transfer process based on the selected transfer request.

### BRIEF DESCRIPTION OF THE SEVERAL VIEWS OF THE DRAWING

FIG. 1 is a configuration diagram showing one example of a system having a DMA controller;

FIG. 2 is a configuration diagram showing one example of descriptors applied to the DMA controller of a first embodiment;

FIG. 3 is a configuration diagram showing the first embodiment of the DMA controller;

FIG. 4 is a configuration diagram showing a second embodiment of the DMA controller; and

FIG. 5 is a configuration diagram showing one example of descriptors applied to the DMA controller of the second embodiment.

### DETAILED DESCRIPTION OF THE INVENTION

There will now be described embodiments of this invention with reference to the accompanying drawings.

### FIRST EMBODIMENT

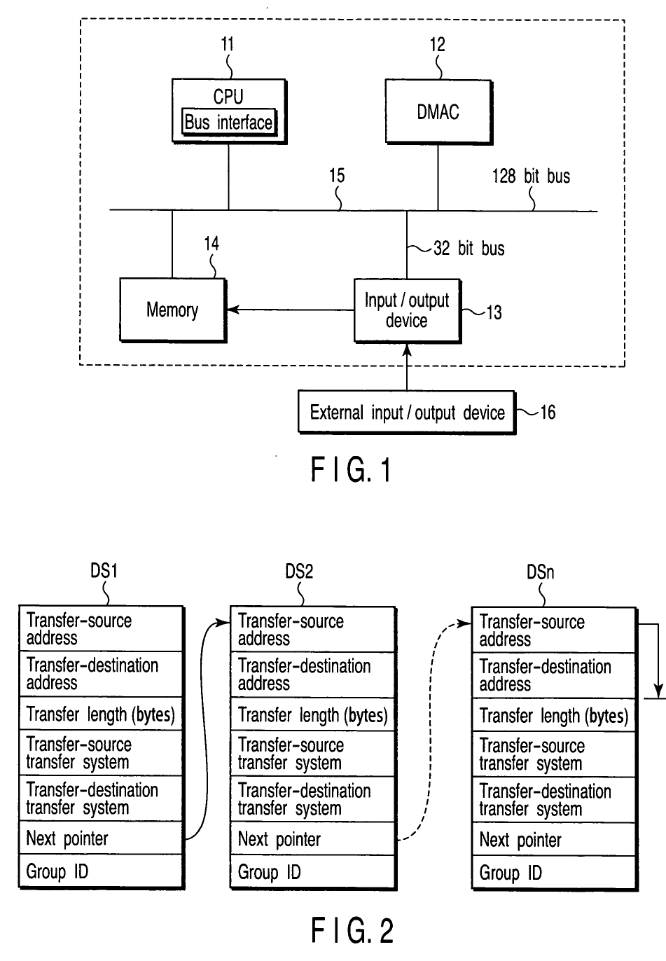

FIG. 1 shows the configuration of a first embodiment of this invention. In FIG. 1, a CPU 11, DMA controller (DMAC) 12, input/output (I/O) device 13 and memory 14 are connected to a bus 15. An external input/output device 16 is connected to the I/O device 13. For example, the CPU 11, DMAC 12, I/O device 13, memory 14 and bus 15 are formed in one chip. The bus 15 has 128-bit data width and a target device of the DMA has 32-bit width, for example. Further, it is assumed that the bus 15 supports data bus sizing at the transfer time based on the protocol thereof. For example, when the CPU 11 transfers 128-bit data via the I/O device 13, the bus interface of the CPU 11 recognizes data width information from the I/O device 13. Thus, the 128-bit data transfer process is performed by automatically dividing the data transfer process into four 32-bit data transfer processes.

It is assumed that the external input/output device 16 continuously transfers a certain amount of data when it starts data transfer to the I/O device 13. In the present embodiment, the data transfer process does not depend on the direction of the DMA. Therefore, for example, it is assumed that data from the external I/O device 16 is transferred to the memory 14 via the I/O device 13.

For example, transfer data is image data and the CPU 11 processes image data stored in the memory 14 on a real-time basis. In this case, it is necessary to transfer image data without interrupting the image process of a next frame. However, when data does not reach the CPU 11 by a certain time due to data jamming on the bus, it becomes unnecessary to continuously transfer data since the present image data has no meaning. Further, at this time, it is necessary to process the image data without interrupting fetching of a next frame.

The I/O device 13 issues a transfer start request to the DMAC 12 when the external input/output device 16 configured by an image input/output device, for example, starts to transfer image data. The DMAC 12 is configured to be supplied with a transfer start trigger from the exterior and makes the DMA process of a preset channel active by using the transfer start request as a trigger. Thus, the transfer process by the I/O device 13 is performed without using the CPU 11.

FIG. 2 shows one example of descriptors applied to the DMAC shown in the first embodiment. FIG. 2 shows n descriptors DS1 to DSn. For example, each descriptor has the processing contents used to transfer data of one horizontal line, for example, a transfer-source address, transfer-destination address, transfer length, transfer-source transfer system, transfer-destination transfer system, next pointer and group identifier (ID). Data of one frame is transferred by use of the descriptors DS1 to DSn of n (equal to the number of horizontal scanning lines). The n descriptors DS1 to DSn are linked by use of the next pointers and transfer-source addresses. The group ID indicates that the n descriptors DS1 to DSn are a series of groups and the descriptors having the same group ID are dealt with as one group. That is, the descriptors contained in a series of groups each contain a common group ID.

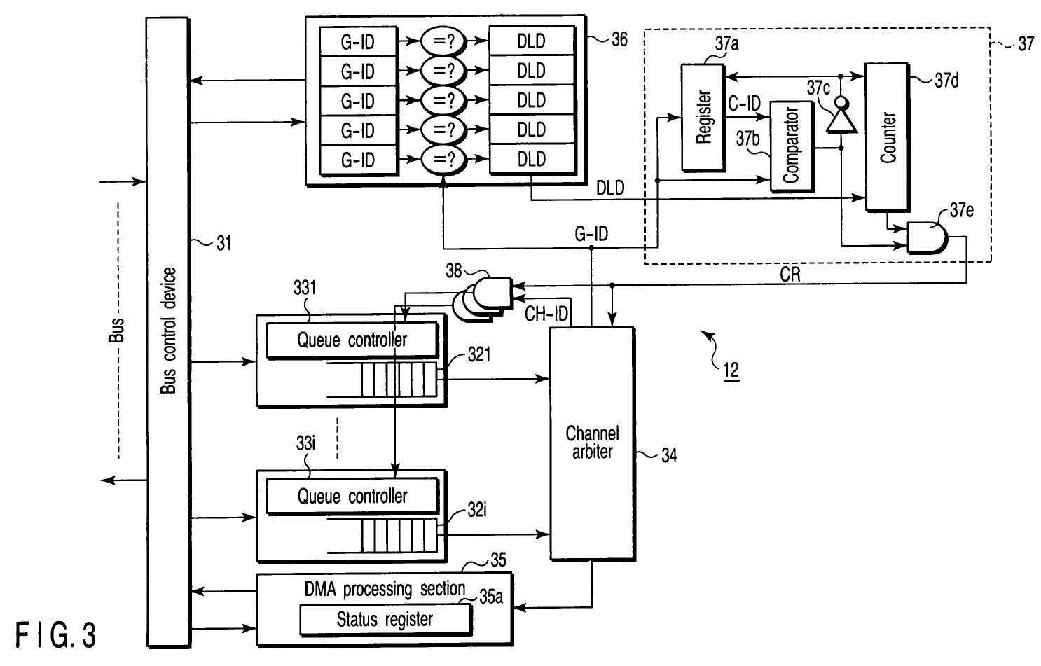

FIG. 3 shows an example of the DMAC 12 applied to the first embodiment. In FIG. 3, the DMAC 12 includes a bus control device 31, a plurality of queues 321 to 32i used as request channels, a plurality of queue controllers 331 to 33i which control the queues 321 to 32i, a channel arbiter 34 which is connected to the queues 321 to 32i to select one of the queues 321 to 32i, a DMA processing section 35 connected to the channel arbiter 34, a memory 36 used as a group ID-latency hash and an elapsed-time determining section 37. The configuration other than the memory 36 and elapse time determining section 37 is a circuit which a normal DMAC has.

The bus control device 31 is connected to the bus 15. The queues 321 to 32i are storage sections each configured by a first-in/first-out register, for example.

The memory 36 is a memory with a content-address memory (CAM) structure, for example, and each stores dead line data (DLD) in correspondence to a group ID (G-ID). Each dead line data is set to time required for transferring data of one frame based on a descriptor chain shown in FIG. 2, for example. That is, the dead line data DLD indicates relative time required for a transfer process of one group configured by a plurality of descriptors. The contents of the memory 36 are rewritten by the CPU 11 via the bus control device 31. The dead line data stored in the memory 36 is read out based on the group ID supplied from the channel arbiter 34. The dead line data thus read out is supplied to the elapsed-time determining section 37.

The elapsed-time determining section 37 manages time required for the transfer process indicated by the group ID and manages the dead line set in the group during the transfer process. For example, the elapsed-time determining section 37 includes a register 37a, comparator 37b, inverter circuit 37c, a counter 37d configured by a saturate down-counter, for example, and a determination unit 37e configured by an AND circuit, for example.

The register 37a stores a current ID during the transfer process. The comparator 37b compares the current ID stored in the register 37a with a group ID. The comparator 37b outputs a high coincidence signal, for example, when the current ID stored in the register 37a coincides with the group ID and outputs a low non-coincidence signal, for example, when the current ID does not coincide with the group ID. The inverter circuit 37c inverts a signal supplied from the comparator 37b and supplies an output signal thereof to the register 37a and counter 37d. The register 37a stores a group ID supplied from the channel arbiter 34 as a current ID when the signal supplied from the inverter circuit 37c is high, for example, that is, when the low non-coincidence signal is output from the comparator 37b. The counter 37d sets dead line data supplied from the memory 36 when the signal supplied from the inverter circuit 37c is high, for example, that is, when the low non-coincidence signal is output from the comparator 37b.

The counter 37d counts down the set dead line data in response to a clock signal, for example, and when the count is set equal to “0”, it holds the count. The counter 37d outputs a low signal, for example, when the count is set at a value other than “0” and outputs a high signal, for example, when the count is set to “0”. The output signal of the comparator 37b and the output signal of the counter 37d are supplied to the determining unit 37e.

The determining unit 37e outputs a cancel request signal CR of high level when the high coincidence signal is supplied from the comparator 37b and a high signal indicating that the count of the counter 37d is “0” is supplied thereto. The output signal of the determining unit 37e is supplied to the channel arbiter 34 and supplied to one-side input terminals of a plurality of AND circuits 38.

Corresponding bits of a channel ID output from the channel arbiter 34 are respectively supplied to the other input terminals of the AND circuits 38. Output signals of the AND circuits 38 are respectively supplied to the queue controllers 331 to 33i.

The memory 36 stores dead line data items in correspondence to the group IDs. However, this is not limitative and, for example, it is possible to store dead line data items in correspondence to channel IDs and group IDs and read out dead line data according to the group ID and channel ID supplied from the channel arbiter 34.

Further, the counter 37d is configured by the saturate down-counter, but this is not limitative. For example, another type of counter or timer can be used instead thereof. Also, an AND circuit configuring the determining unit 37e and the AND circuits 38 are shown as one example and it is of course possible to modify the AND circuit into another logical circuit according to the logical configuration.

The operation of the circuit with the above configuration is explained below. First, a descriptor is set as a transfer request in a request channel. That is, descriptors divided into groups by use of the group IDs as shown in FIG. 2 are stored from the CPU 11 into a plurality of queues 321 to 32n via the bus control device 31. Storage of the descriptors into the queues 321 to 32n is performed actively by the DMAC 12 or by control of the CPU 11. The channel arbiter 34 has a normal configuration and selects one channel from a plurality of request channels. Further, the channel arbiter 34 fetches a first descriptor stored in the queue of the selected channel and sends the first descriptor to the DMA processing section 35. The operation of the DMAC 12 is the same as the operation of the normal DMAC except the transfer process canceling operation. That is, when the DMA processing section 35 receives the descriptor from the channel arbiter 34, the transfer process is performed according to a transfer-source address, transfer-destination address, transfer length and a transfer-destination transfer system and transfer-source transfer system which each hold an address counting method at the transfer time described in the descriptor. Further, the DMA processing section 35 has a status register 35a which contains flags each indicating interruption of corresponding transfer. When the transfer is interrupted, the DMA processing section sets the effect that the transfer process of the request channel is interrupted in a corresponding one of the flags of the status register 35a and notifies the CPU of the interrupted request channel.

Next, the transfer process canceling operation by the DMAC 12 is explained.

As described before, the channel arbiter 34 fetches a first descriptor stored in the queue corresponding to the selected channel and takes out a group ID from the descriptor. The group ID is supplied to the memory 36. When the group ID stored in the memory 36 coincides with the group ID supplied thereto, the memory 36 outputs dead line data corresponding to the group ID.

The elapsed-time determining section 37 receives a group ID supplied from the channel arbiter 34 and dead line data supplied from the memory 36. The comparator 37b compares a current ID output from the register 37a with the group ID supplied from the channel arbiter 34. If it is detected as the comparison result that the current ID and group ID do not coincide with each other, it is determined that a transfer request group has been changed. Then, a group ID supplied from the channel arbiter 34 is set in the register 37a according to the output signal of the inverter circuit 37c. At this time, dead line data supplied from the memory 36 is set in the counter 37d.

As described before, in this state, the DMA processing section 35 performs the transfer process according to the description of the descriptor. The counter 37d counts down the set dead line data. At this time, a coincidence signal is output from the comparator 37d as the result of comparison of the current ID and group ID. In this state, when the count of the counter 37d is set to “0”, that is, when a dead line occurs while the present transfer request is being processed, the counter 37d outputs a high signal. Therefore, a high cancel request CR, for example, is output from the determining unit 37e. The cancel request CR is supplied to the channel arbiter 34 and a plurality of AND circuits 38. Each of the AND circuits 38 is supplied with a corresponding bit of the channel ID. Therefore, the cancel request CR is supplied to one of the queue controllers 331 to 33i which is a queue controller of a channel which is indicated by the channel ID and is now subjected to the transfer process.

The queue controller supplied with the cancel request CR erases the first descriptor of the queue, that is, the descriptor which is now dealt with. At the same time, the channel arbiter 34 fetches the succeeding descriptor from the selected queue according to the cancel request CR. The group ID of the descriptor is supplied to the comparator 37b. When the group ID and current ID coincide with each other, a coincidence signal is output from the comparator 37b. At this time, since the output signal of the counter 37d is kept high, a cancel request CR is output from the determining unit 37e. Therefore, the descriptor is also canceled. Thus, the descriptors having the common group ID are sequentially erased.

When the group ID fetched by the channel arbiter 34 is different from the current ID, the contents of the register 37a and counter 37d are updated and a new transfer process is performed. That is, in this case, a non-coincidence signal is output from the comparator 37b. Therefore, a new group ID is set in the register 37a and dead line data read out from the memory 36 according to the group ID is set in the counter 37d. Thus, a new group transfer operation is performed as described above.

According to the first embodiment, each of the descriptors configuring a series of groups has the common group ID and the DMAC 12 includes the memory 36 which stores dead line data corresponding to a group ID and the counter 37d which counts down dead line data output from the memory 36. When the elapsed-time determining section 37 detects a dead line of the group ID which is now subjected to the transfer process while the DMA processing section 35 is performing the transfer process, descriptors having the common group ID are sequentially erased from the queue. Thus, since a large number of descriptors can be stably erased in a short period by use of the DMAC 12, the load on the CPU 11 can be reduced and the processing efficiency can be prevented from being lowered.

### SECOND EMBODIMENT

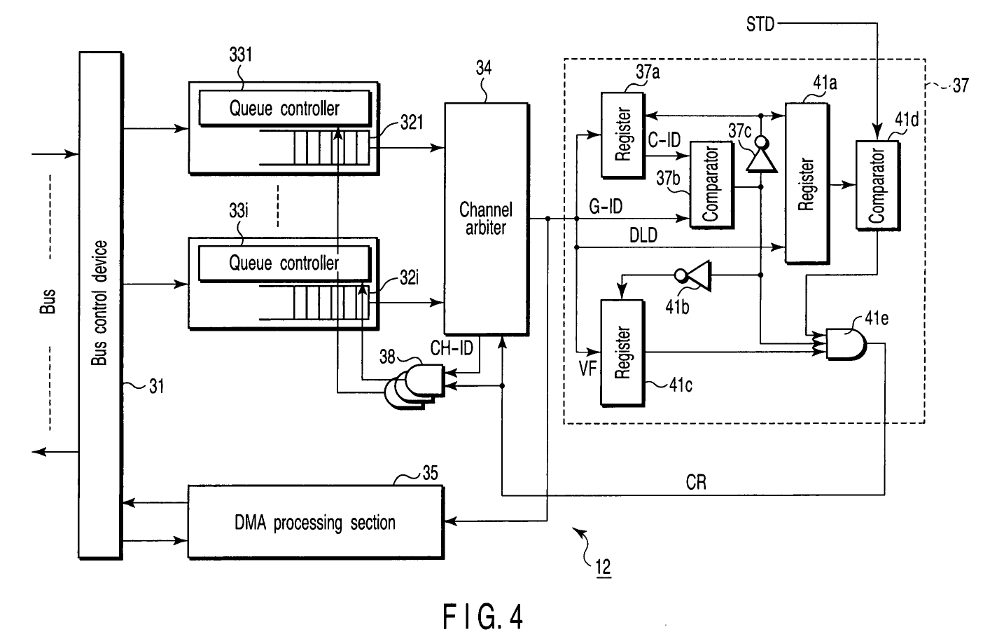

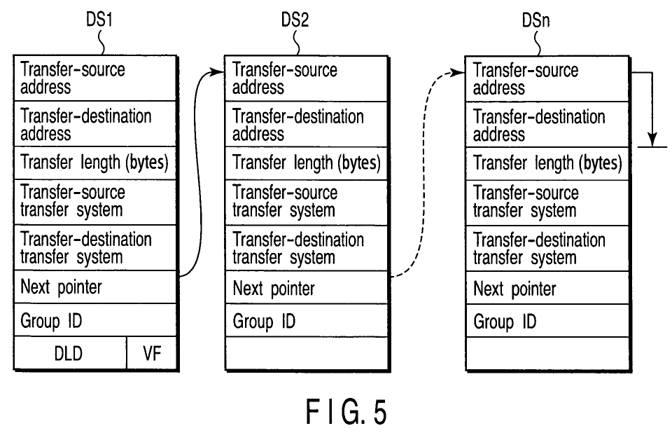

FIGS. 4 and 5 show a second embodiment of this invention. FIG. 4 shows the configuration of a DMAC 12 and FIG. 5 shows the configuration of descriptors.

In the first embodiment, the DMAC 12 internally manages the elapsed-time of the transfer process based on the dead line data stored in the memory 36. On the other hand, in the second embodiment, the elapsed-time of the transfer process is managed by use of time information supplied from the exterior of the DMAC 12.

First, the configuration of the descriptor shown in FIG. 5 is explained. In the second embodiment, a first descriptor DS1 of a descriptor chain configured by a plurality of descriptors DS1 to DSn has dead line data DLD and a valid flag VF. The dead line data DLD indicates time at which the transfer process performed by a plurality of descriptors divided into groups by use of group IDs is terminated. The above time is absolute time managed by the CPU 11, for example. However, the time is not limited to this case and can be set to any time if the time can be commonly recognized by the DMAC 12 and CPU 11. Further, the valid flag VF indicates validity or invalidity of the transfer end time as the dead line data DLD. The dead line data DLD and valid flag VF are set by the CPU 11.

Next, the DMAC 12 shown in FIG. 4 is explained. In FIG. 4, portions which are the same as those of FIG. 3 are denoted by the same reference symbols and only different portions are explained.

The descriptors divided into groups as shown in FIG. 5 are stored from the CPU 11 into a plurality of queues 321 to 32n via a bus control device 31. Storage of the descriptors into the queues 321 to 32n is performed actively by the DMAC 12 or by control of the CPU 11. A channel arbiter 34 fetches a first descriptor stored in the queue of the selected channel and sends the first descriptor to the DMA processing section 35. At this time, the channel arbiter 34 fetches a first descriptor stored in the queue corresponding to the selected channel and takes out a group ID, dead line data DLD and valid flag VF from the fetched descriptor. The group ID, dead line data DLD and valid flag VF are supplied to an elapsed-time determining section 37.

The elapsed-time determining section 37 includes a register 41a, inverter circuit 41b, register 41c, comparator 41d and determining unit 41e in addition to a register 37a, comparator 37b, inverter circuit 37c.

The register 41a holds dead line data DLD according to an output signal of the inverter circuit 37c when a non-coincidence signal is output from the comparator 37b. Further, the register 41c holds the valid flag VF in response to the output signal of the inverter circuit 41b when a coincidence signal is output from the comparator 37b. The comparator 41d compares dead line data DLD held in the register 41a with time data STD indicating the present time of the system and supplied from the CPU 11, for example. The result of comparison by the comparator 41d is supplied to the determining unit 41e configured by an AND circuit, for example, together with an output signal from the comparator 37b and a valid flag supplied from the register 41c. If the determining unit 41e is supplied with the coincidence signals from the comparators 41d and 37b and when the valid flag VF supplied from the register 41c indicates validity, it outputs a cancel request CR used to cancel the transfer process. The cancel request CR is supplied to the channel arbiter 34 and AND circuit 38.

The operation of the circuit with the above configuration is explained. The transfer process is the same as that of the first embodiment. During the transfer process, the comparator 41d compares dead line data DLD held in the register 41a with time data STD supplied from the CPU 11. As a result of comparison, if the two compared data items coincide with each other, it is determined that the set time has elapsed and the comparator 41d outputs a high coincidence signal, for example. At this time, since the current ID held in the register 37a and the group ID supplied from the channel arbiter 34 coincide with each other, the comparator 37b outputs a high coincidence signal, for example. Further, since the register 41c holds an effective valid flag VF, it outputs a high signal. Therefore, since the input condition of the determining unit 41e is satisfied, it outputs a high cancel request CR, for example. The cancel request CR is supplied to the channel arbiter 34 and a plurality of AND circuits 38. Each of the AND circuits 38 is supplied with a corresponding bit of the channel ID. Therefore, a cancel request CR is supplied to the queue controller of a channel which is indicated by the channel ID and is now used for transferring among the queue controllers 331 to 33i.

The queue controller which is supplied with the cancel request CR erases the first descriptor of the queue, that is, a descriptor which is now dealt with. At the same time, the channel arbiter 34 fetches a succeeding descriptor from the selected queue according to the cancel request CR. The group ID of the descriptor is supplied to the comparator 37b. When the group ID coincides with the current ID, a coincidence signal is output from the comparator 37b. Further, since the output signal of the comparator 41d is kept high, a cancel request CR is output from the determining unit 37e. Therefore, the descriptor is also canceled. Thus, descriptors having the common group ID are sequentially erased from the queue.

When the group ID fetched by the channel arbiter 34 is different from the current ID, the contents of the register 37a and registers 41a, 41c are updated and a new transfer process is performed. That is, in this case, a non-coincidence signal is output from the comparator 37b. Therefore, a new group ID is set in the register 37a as a current ID, dead line data supplied from the channel arbiter 34 is set in the register 41a and a valid flag VF is set in the register 41c. Thus, a new group transfer operation is performed as described above.

According to the second embodiment, the dead line data DLD used as a transfer process time limit is set in the first descriptor among a plurality of descriptors divided into groups based on absolute time. During the transfer process, if the dead line data DLD fetched from the first descriptor coincides with the present time from the CPU 11, it is determined that the transfer process time has elapsed and descriptors having the common group ID are sequentially erased from the queue. Thus, since a large number of descriptors can be stably erased in a short time by use of the DMAC 12, the load on the CPU 11 can be reduced and the processing efficiency can be prevented from being lowered.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data transfer apparatus comprising:
a transfer processing section which transfers data in response to a transfer request;
a plurality of transfer request storing sections which store a plurality of transfer requests having identifiers attached thereto;
a selecting section which selects one of the plurality of transfer request storing sections, the selecting section sequentially fetching the plurality of transfer requests stored in a selected one of the plurality of transfer request storing sections and supplying the same to the transfer processing section;
a first storage section which stores the identifiers and time information indicating end time of a transfer process based on the plurality of transfer requests having the identifiers attached thereto, the first storage section outputting time information based on an identifier contained in the transfer request supplied from the selecting section; and
a determining section which determines processing time of the plurality of transfer requests based on time information supplied from the first storage section, the determining section generating a cancel request signal used to cancel transfer requests issued after the present transfer request and supplying the cancel request signal to the transfer request storing section when the processing time has exceeded time indicated by the time information.

2. The device according to claim 1, wherein the determining section includes a register which stores an identifier of a group which is now subjected to the transfer process, a comparator which compares an identifier supplied from the selecting section with the identifier stored in the register, a counter in which time information supplied from the storage section is set when a non-coincidence signal is output from the comparator and which counts down the time information, and a deciding section which outputs the cancel request signal when a signal indicating that the count of the counter is “0” is supplied thereto and a coincidence signal is supplied from the comparator.

3. The device according to claim 2, wherein the identifier is attached to each of the transfer requests.

4. The device according to claim 1, wherein the first storage section includes a contents-addressing memory.

5. The device according to claim 1, further comprising a bus control section which is connected to the transfer processing section, the plurality of transfer request storing sections and the first storage section.

6. The device according to claim 5, wherein each of the transfer request storing sections includes a first-in/first-out register.

7. A data transfer apparatus comprising:
a transfer processing section which transfers data in response to a transfer request;
a plurality of transfer request storing sections which store a plurality of transfer requests having identifiers attached thereto;
a selecting section which selects one of the plurality of transfer request storing sections, the selecting section sequentially fetching the plurality of transfer requests stored in a selected one of the plurality of transfer request storing sections and supplying the same to the transfer processing section; and
a determining section which generates a cancel request signal used to cancel transfer requests issued after the present transfer request and supplying the cancel request signal to the transfer request storing section when end time of the transfer process set based on the plurality of transfer requests has exceeded present time supplied from the exterior.

8. The device according to claim 7, wherein the determining section includes a first register which stores an identifier of a transfer request which is now subjected to the transfer process, a first comparator which compares an identifier supplied from the selecting section with the identifier stored in the register, a second register which holds the end time supplied from the selecting section when a non-coincidence signal is output from the comparator, a second comparator which compares the end time held in the second register with present time supplied from the exterior, and a deciding section which outputs the cancel request signal when coincidence signals are supplied thereto from the first and second comparators.

9. The device according to claim 8, wherein the determining section further includes a third register which holds the flag supplied from the channel arbiter and the determining section outputs the cancel request signal based on an output signal of the third register and the coincidence signals supplied from the first and second comparators.

10. The device according to claim 9, wherein the end time of the transfer process is attached to a first one of the plurality of transfer requests which are divided into groups.

11. The device according to claim 10, wherein the first transfer request includes a flag indicating one of validity and invalidity of the end time.

12. The device according to claim 7, wherein the present time supplied from the exterior is present time of a system output from a CPU.

13. The device according to claim 7, further comprising a bus control section connected to the transfer processing section, the plurality of transfer request storing sections and the first storing section.

14. The device according to claim 13, wherein each of the transfer request storing sections includes a first-in/first-out register.

15. A data transfer method comprising:
selecting one of a plurality of transfer requests;
setting end time of a transfer process corresponding to an identifier attached to the selected transfer request; and
canceling the selected transfer request when the set end time has elapsed during the data transfer process based on the selected transfer request.

16. The method according to claim 15, wherein the end time is stored in a storage section in correspondence to the identifier and the end time corresponding to an identifier attached to the selected transfer request is output from the storage section when the transfer request is selected.

17. The method according to claim 16, wherein the end time output from the storage section is counted down.

18. The method according to claim 15, wherein the end time is attached to the transfer request corresponding to the identifier.

19. The method according to claim 18, wherein the selected transfer request is erased when time data supplied from the exterior coincides with the end time.

20. The method according to claim 19, wherein the time data indicates present time of a system output from a CPU.
